(19) United States
(12) Patent Application Publication
(10) Pub. No.: US 2007/0221247 A1
(43) Pub. Date: Sep. 27, 2007

(54) Scouring Element For Cleaning Points That Are Difficult To Access

(75) Inventors: Stefan Duda, Frankenthal (DE); Ralf Elsasser, Augsburg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Carl Freudenberg KG, Weinheim (DE)

(21) Appl. No.: 11/571,926

(22) PCT Filed: Jun. 16, 2005
(86) PCT No.: PCT/EP05/06444

§ 371 Date: Feb. 23, 2007

(30) Foreign Application Priority Data
Aug. 14, 2004 (DE) 102004039516.0

(51) Int. Cl. B08B 1/00; B32B 38/00

(52) U.S. Cl. 134/6; 15/104.93; 156/278

(57) ABSTRACT

Disclosed is a scouring cloth (1) comprising a support material (2) which is made of a planar textile structure (3), is formed by a fleece material that is compacted by water jet, and is provided with at least one cleaning area (4) with an embossed pattern (5). The cleaning area (4) is covered with a scouring agent composition (6) that is disposed on the cleaning area (4).

### TECHNICAL FIELD

The subject matter of the present invention relates to a scouring body that comprises a substrate material made of a textile fabric as well as a method for its production.

### PRIOR ART

Scouring bodies of this type are known from EP 0 696 432 A1. The prior-art scouring body is made of a textile material on the basis of natural and synthetic fibers. A working surface of the scouring body has a relief pattern which was produced by means of hot-forming the textile material. In addition, the working surface also has areas that are covered with a scouring composition. The disadvantage of the prior-art scouring body is that the production requires a large number of processing steps.

Frequently, the substrate material of the scouring bodies is a foamed plastic. This has the disadvantage that it is difficult to use in hard-to-access areas.

### DISCLOSURE OF THE INVENTION

The problem to be solved by the present invention is to make available a scouring body that can be produced easily and inexpensively and that has an improved cleaning action in hard-to-access areas, for example, corners and edges.

This problem is solved by the characteristics of claims 1 and 11. Advantageous embodiments are described in the dependent claims.

To solve the problem, the scouring body comprises a substrate material made of a textile fabric that is formed by a hydroentangled nonwoven material and that has at least one cleaning surface with a relief pattern, with the cleaning surface being covered with a scouring composition that is disposed on the cleaning surface.

Because of the hydroentanglement, it is possible to make available a nonwoven material that has a low mass per unit area and a lower thickness. A hydroentangled nonwoven material has a higher strength than, for example, a mechanically needle-punched nonwoven material. A scouring body made of such a nonwoven material has both a low thickness and a high strength, which makes such a scouring body especially well suited for cleaning hard-to-access areas. The relief pattern improves the cleaning action of the scouring body on stubborn soil. The cleaning action is further improved by the scouring composition that has been applied to the cleaning surface.

The scouring cloth can have only one cleaning surface and one gripping surface, with the gripping surface being formed by the textile fabric. A nonwoven material that is bonded by means of hydroentanglement has a pleasant textile and soft hand feel. Because of this, it is possible to use the nonwoven material directly as the gripping surface. As a result, the scouring body has a low thickness and is flexible, which improves the cleaning of hard-to-access areas.

The scouring composition can comprise a binding agent and scouring particles. The binding agent ensures that the scouring particles are intimately bound. A solution comprising a binding agent and the scouring particles can be applied easily and inexpensively by spraying it onto the textile fabric. The binding agent further strengthens the scouring body.

In one embodiment, the binding agent can be based on a phenol resin. A phenol resin-based binding agent has a high hardness and a high abrasion resistance. In another embodiment, the binding agent can be based on an acrylate. Acrylate-based binding agents have a pleasant hand feel. In yet another embodiment, the binding agent can be made of a mixture of acrylate and phenol resin. In this case, the properties of both binding agents influence the feel and the hardness of the material.

The scouring particles can be formed by mineral and/or organic scouring particles. Mineral abrasives to be used include, for example, quartz, aluminum oxide, silicon carbide, chalk or glass granules. Mineral abrasives are very durable and inexpensive. Mineral abrasives have a high hardness and therefore have an abrasive scouring action. Mineral abrasives are therefore especially well suited for the removal of stubborn soil.

Non-mineral or organic abrasives include, for example, polyurethane, PMMA or nutshells. Non-mineral or organic abrasives can be easily processed and are inexpensive as well. The non-mineral or organic abrasives are not as hard as mineral abrasives. These abrasives therefore do not have an abrasive scouring action and are especially well suited for cleaning sensitive surfaces.

The relief pattern can be formed by a nubby structure with circular nubs. Circular nubs are simple geometric shapes that can be easily produced. A large number of protuberances in the form of nubs can be disposed on the cleaning surface. The use of circular nubs avoids continuous grooves in which soil can collect.

The ratio between the thickness of the substrate material and the thickness of the scouring composition can be in a range from 1:2 to 1:10, preferably it is 1:5. At this ratio, a thin scouring body with a high scouring action is obtained. In this case, the scouring body does not absorb a large quantity of water.

The scouring body can have a thickness of a maximum of 3 mm, preferably of 1 mm. Such a scouring body has a low thickness but a sufficiently high stability. Because of the low thickness, the scouring body is especially well suited for cleaning hard-to-access areas and can be stored without talking up much space.

The mass per unit area of the textile fabric can be in a range from 50-200 g/m², it is preferably 150 g/m². A scouring body made of such a textile fabric is light-weight and, because of the hydroentanglement, stable.

In addition, the problem is also solved by a method for the production of a scouring body, which method comprises the following steps:

production of a textile fabric (3) from a fiber material (11);

bonding the textile fabric (3) and shaping at least the one cleaning surface (4) by means of hydroentanglement;

preparation of a scouring composition by mixing a binding agent (8) with scouring particles (9); and

spraying the scouring composition (6) onto the cleaning surface (4).

Shaping the relief pattern, for example, the raised circular nubs and bonding the fiber material made from the fiber material [sic] takes place in one step. Thus, an additional processing step, such as would be required if the nubs were produced by means of hot-forming, is eliminated. Mixing the scouring composition with a binding agent prior to application makes it possible to change or even to omit the scouring particles. The quantity of the scouring composition (6) to be applied is in a range from 220-300 g/m². Scouring bodies with different compositions of binding agents and scouring particles can thus be produced easily and inexpensively. By spraying the scouring composition on after forming the relief structure, the nubs are additionally bonded and stabilized.

In another solution of the problem, the scouring body is used as a disposable cloth. The cleaning cloth can be produced easily and inexpensively and, because of its low thickness, takes up little space. As a result, it is especially well suited for use as a disposable cleaning cloth.

### BRIEF DESCRIPTION OF THE DRAWINGS

A few practical examples of the scouring body according to the present invention will be explained in greater detail below based on the figures. As can be seen, the drawings in the form of diagrams include:

FIG. 1 shows a cross section through the scouring body according to the present invention;

FIG. 2 shows a top view of the scouring body according to the present invention; and

FIG. 3 shows a cross section through the scouring body according to the present invention.

### MEANS FOR CARRYING OUT THE INVENTION

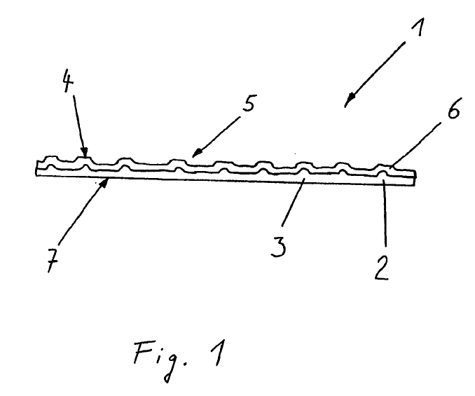

FIG. 1 shows a scouring body 1 according to the present invention. The scouring body 1 comprises a substrate material 2 that has a cleaning surface 4 with a relief pattern 5. The cleaning surface 4 is covered with a scouring composition 6. The surface of the textile fabric 3 facing away from the cleaning surface 4 forms the gripping surface of the scouring body 1. The substrate material 2 consists of a textile fabric 3 that is formed from a hydroentangled nonwoven material. Given a thickness of the scouring body 1 of 1 mm, the ratio between the thickness of the substrate material 2 and the thickness of the scouring composition 6 is 1:5. The thickness of the scouring body is determined by the thickness of the substrate material and the scouring composition, including the height of the nubs 10. In this embodiment, the mass per unit area of the textile fabric measures 150 g/m². The scouring body 1 can be used as a disposable scouring body.

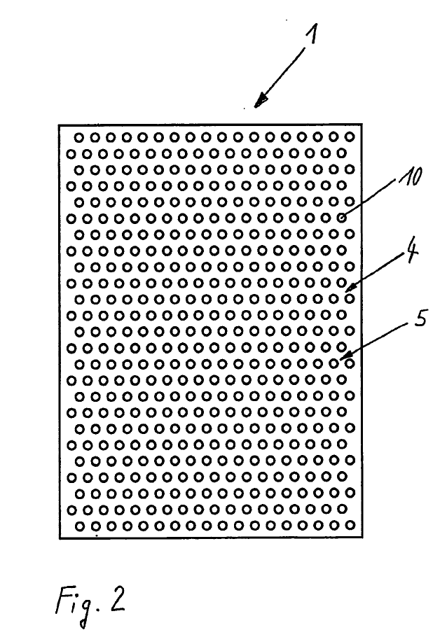

FIG. 2 shows a top view of the scouring body seen in FIG. 1. The relief pattern 5 is formed by circular nubs 10, with the circular nubs 10 being disposed hexagonally on the cleaning surface 4, which results in the largest possible number of nubs 10 per unit area.

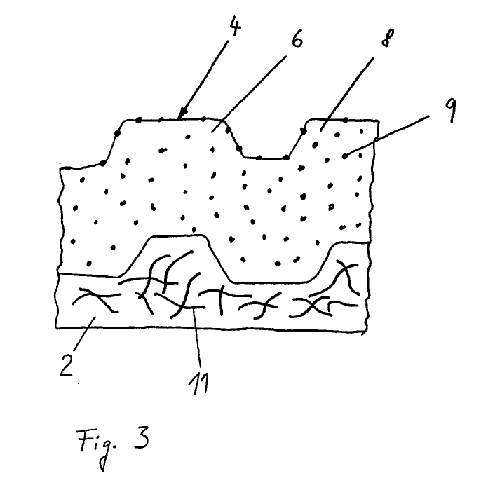

FIG. 3 shows a section of the scouring body 1 seen in FIGS. 1 and 2. The scouring composition covering the cleaning surface 4 comprises a binding agent 8 and scouring particles 9 that are mixed into the binding agent 8. The binding agent 8 can have a phenol resin base or an acrylate base. The scouring particles 9 can be formed by mineral or organic or a mixture of mineral and organic scouring particles 9.

To produce the scouring body, first a textile fabric 3 made from a nonwoven material is produced from a fiber material 11. The bonding of the textile fabric 3 takes place by means of hydroentanglement. In the same processing step, the cleaning surface 4 is shaped. Thus, the circular nubs 10 are also produced by means of hydroentanglement. The scouring composition 6 is produced by mixing a binding agent 8, for example, a phenol resin-based or an acrylate-based binding agent 8, with scouring particles 9, for example, mineral or organic scouring particles 9. The scouring composition 6 is applied by spraying it onto the cleaning surface 4. To cure the scouring composition, the scouring body 1 can be heat-treated in a furnace.

1. A scouring body comprising a substrate material made of a textile fabric that is formed from a hydroentangled nonwoven material and at least one cleaning surface with a relief pattern, with the cleaning surface being covered with a scouring composition that is disposed on the cleaning surface.

2. The scouring body as in claim 1, wherein the scouring cloth has only one cleaning surface and one gripping surface, with the gripping surface being formed by the textile fabric.

3. The scouring body as in claim 1, wherein the scouring composition consists of a binding agent and scouring particles.

4. The scouring body as in claim 3, wherein the binding agent is phenol resin-based.

5. The scouring body as in claim 3, wherein the scouring particles are formed by mineral scouring particles.

6. The scouring body as in claim 1, wherein the relief pattern is formed by a nub structure with circular nubs.

7. The scouring body as in claim 1, wherein the ratio between the thickness of the substrate material and the thickness of the scouring composition is in a range from 1:2-1:10.

8. The scouring body as in claim 1, wherein the scouring cloth has a thickness of a maximum of 3 mm.

9. The scouring body as in claim 1, wherein the mass per unit area of the textile fabric is in a range from 50 to 200 g/m².

10. A method for the production of a scouring body, which method comprises the following steps:
production of a textile fabric from a fiber material;
bonding the textile fabric and shaping at least the one cleaning surface by means of hydroentanglement;
preparing a scouring composition by mixing a binding agent with scouring particles; and
spraying the scouring composition onto the cleaning surfaced.

11. The use of the scouring body as in claim 1 as a disposable scouring cloth.

12. The scouring body as in claim 3, wherein the binding agent is acrylate based.

13. The scouring body as in claim 3, wherein the scouring particles are formed by organic scouring particles.
